(19) United States
(12) Patent Application Publication
(10) Pub. No.: US 2012/0011953 A1
(43) Pub. Date: Jan. 19, 2012

(54) BALL BEARING FOR RAM AIR TURBINE GEARBOX

(76) Inventor: Stephen Michael Bortoli, Rockton, IL (US)

(21) Appl. No.: 12/837,937

(22) Filed: Jul. 16, 2010

(51) Int. Cl. F16H 57/02; B23P 19/04; F16C 33/58

(52) U.S. Cl. 74/412 R; 384/569; 29/724

(57) ABSTRACT

A ram air turbine gearbox includes a pinion shaft arranged in a housing and operatively supports a pinion gear. An input shaft is arranged in the housing and operatively supports a ring gear coupled to the pinion gear. The input and output shafts are oriented at an angle. A rolling element bearing supports the pinion shaft in the housing and includes inner and outer races between which a multiple ball bearings are arranged. Each ball includes a ball diameter. The inner and outer races respectively include inner and outer raceway radii and inner and outer raceway depths. The inner and outer raceway radii each are approximately 52% of the ball diameter. The inner raceway depth is at a minimum 25% of the ball diameter, and the outer raceway depth is at a minimum 20% of the ball diameter.

### BACKGROUND

This disclosure relates to a ram air turbine gearbox, and more particularly, a ball bearing for use in a ram air turbine gearbox.

Ram air turbine gearboxes transfer torque from a turbine to a power use point. The gearbox includes an input shaft to which the turbine is connected and an output shaft interconnecting the input shaft and the power use point. In some applications the surface geometry of the mating gear teeth will generate non-radial loads that are reacted by the bearings. Typical ball bearings may be unsuitable for this configuration such that roller bearings are typically required to accommodate radial loads while another paired, larger, and different ball bearing is needed to react the axial loads. The use of roller bearings may be necessary for gearbox applications that have very limited space available to the bearings, preventing the use of typical larger ball bearings needed to withstand the radial loads. Unfortunately, roller bearing life may be susceptible to the misalignment inherent to such applications.

### SUMMARY

A ram air turbine gearbox is disclosed that includes a pinion shaft arranged in a housing and operatively supports a pinion gear. An input shaft is arranged in the housing and operatively supports a ring gear coupled to the pinion gear. The input and output shafts are oriented at an angle relative to one another. A rolling element bearing supports the pinion shaft in the housing. The rolling element bearing includes inner and outer races between which multiple balls are arranged. Each ball includes a ball diameter. The inner and outer races respectively include inner and outer raceway radii and inner and outer raceway depths. The inner and outer raceway radii each are approximately 52% of the ball diameter. The inner raceway depth is approximately 25% of the ball diameter, and the outer raceway depth is approximately 20% of the ball diameter. A total diametral internal radial clearance between the balls and races is 0.0012-0.0016 inch (0.0305-0.0406 mm).

### BRIEF DESCRIPTION OF THE DRAWINGS

The disclosure can be further understood by reference to the following detailed description when considered in connection with the accompanying drawings wherein:

FIG. 1 is a perspective view of a ram air turbine (RAT) for an aircraft.

FIG. 2 is a cross-sectional view of an example gearbox including ball bearings supporting a pinion shaft.

FIG. 3 is an enlarged cross-sectional view of a portion of the ball bearing.

### DETAILED DESCRIPTION

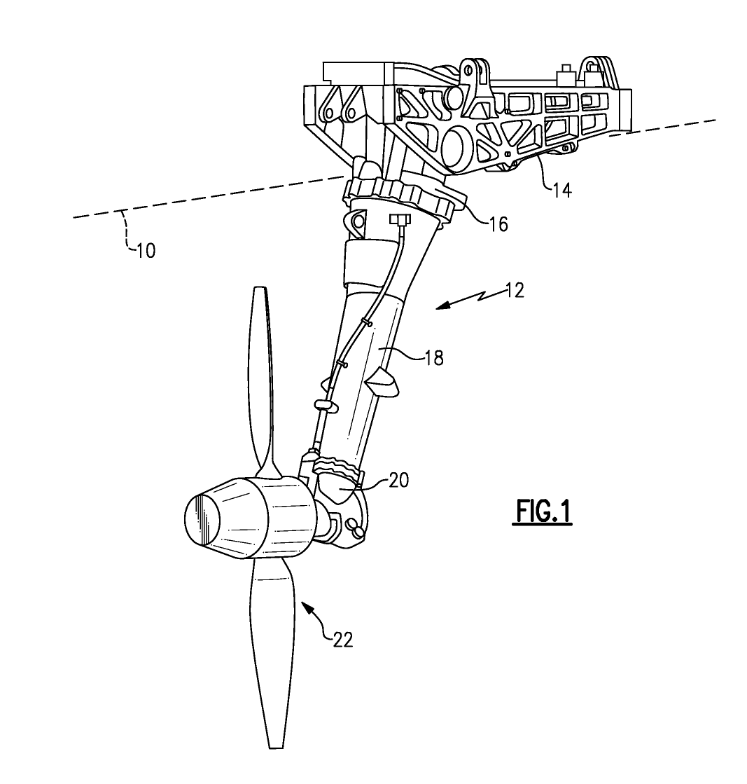

An example ram air turbine (RAT) 12 for an aircraft 10 is shown in a deployed position in FIG. 1. The RAT 12 includes a generator 16 pivotally supported by a mounting structure 14 that is secured to the aircraft 10. A strut 18 extends from the generator 16 and supports a gearbox 20. The turbine blades 22, which are rotationally driven by airflow in the deployed position, drive the generator 16 through the gearbox 20.

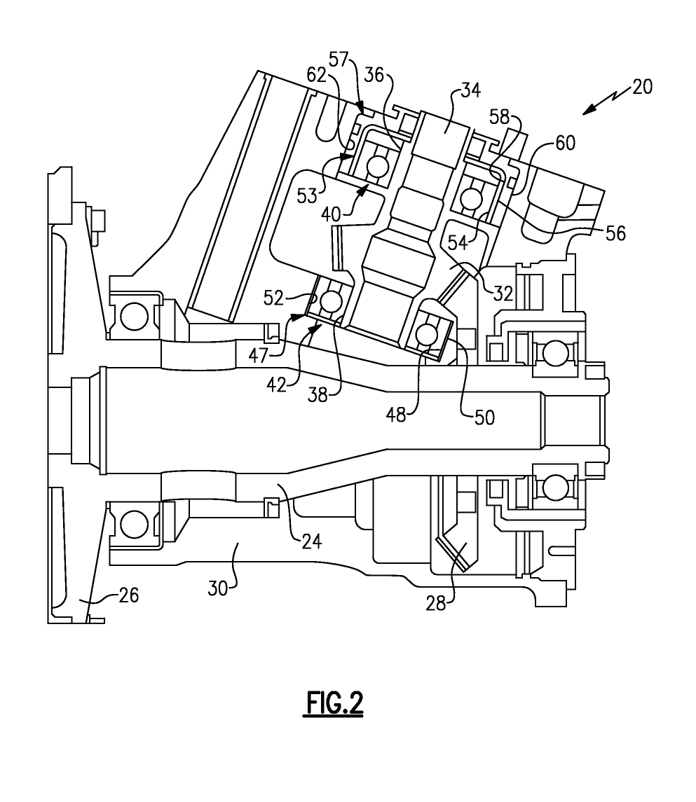

Referring to FIG. 2, the gearbox 20 includes an input shaft 24 mounted for rotation within a housing 30 constructed from aluminum. The turbine blades 22 are secured to a hub 26 provided on the input shaft 24. A ring gear 28 is operatively mounted on the input shaft 24 and is coupled to a pinion gear 32 operatively mounted on a pinion shaft 34.

The pinion shaft 34 includes upper and lower shaft portions 36, 38 provided on either side of the pinion gear 32. The upper and lower shaft portions 36, 38 each include an outer diameter supported for rotation relative to the housing 30 by upper and lower bearings 40, 42, respectively. The bearings 40, 42 are interchangeable and are designed to an ABEC-5 tolerance. The outer diameters of the upper and lower shaft portions 36, 38 are nominally 1.1817 inch (30.0152 mm). An outer diameter 46 of the upper and lower bearings 40, 42 is nominally 2.4409 inch (62.0000 mm), and an inner diameter 44 is nominally 1.1811 inch (30.0000 mm).

A lower bearing liner 47 is provided between the lower bearing 42 and the housing 30. The lower bearing liner 47 includes a lower liner inner diameter 48 that is nominally 2.4430 inch (62.0522 mm) and a lower liner outer diameter 50 that is nominally 2.5432 inch (64.5973 mm). A lower housing inner diameter 52 is nominally 2.5380 inch (64.4652 mm).

An upper bearing liner 53 is provided between the upper bearing 40 and a bearing can 57. The bearing liners 47, 53 are constructed from stainless steel. The upper bearing liner 53 includes upper liner inner and outer diameters 54, 56 that are respectively nominally 2.4421 inch (62.0293 mm) and 2.5958 inch (65.9333 mm). The bearing can 57, which is constructed from aluminum, includes bearing can inner and outer diameters 58, 60 that are respectively 2.5920 inch (65.8368 mm) and 3.0620 inch (77.7748 mm). The housing 30 includes an upper housing inner diameter 62 that is nominally 3.0650 inch (77.8510 mm). The diameters of the components are given when the component is in its free-state, that is, uninstalled. The pinion shaft 34, lower and upper liners 47, 53, bearing can 57 and housing 30 are in a press fit relationship with one another when installed, as can be appreciated by the components' free-state dimensions.

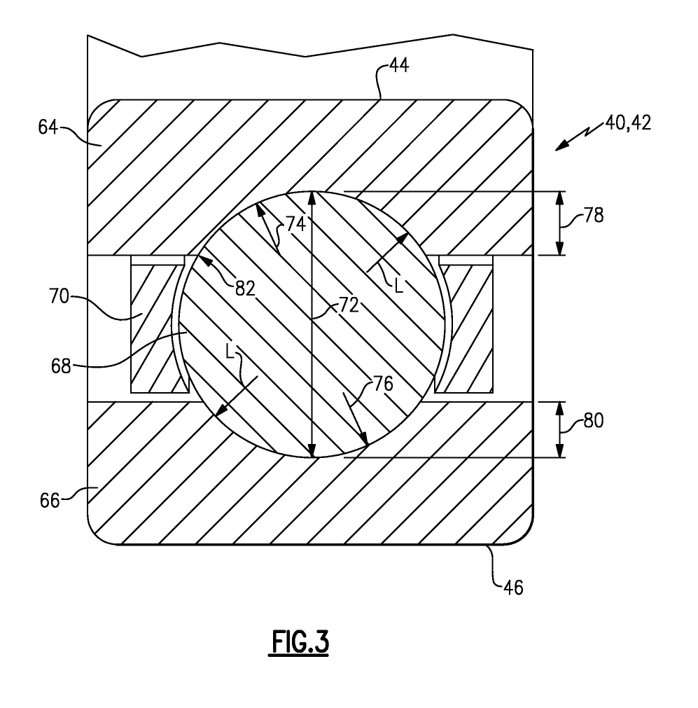

Referring to FIG. 3, the upper and lower bearings 40, 42 each include inner and outer races 64, 66, with a hardness of HRC 60-64. Nine balls 68 having a hardness of HRC 60-65 are arranged between the races 64, 66. The races 64, 66 and balls 68 are constructed from AMS5618 440 C. In the example, the balls 68 have a diameter 72 of 0.3750 inch (9.5250 mm) and are grade 10. The balls 68 are captured in desired circumferential positions with a cage 70 constructed of silver-plated AMS6415 434D. The cage 70 has circumferentially spaced pockets that each provide a clearance relative to its respective ball 68 of 0.010-0.018 inch (0.254-0.356 mm).

The inner and outer races 64, 66 each respectively include inner and outer raceway radii 74, 76 that are approximately 52% of the ball diameter 72. The inner and outer raceway radii 74, 76 respectively include inner and outer raceway depths 78, 80 that are respectively at a minimum 25% and 20% of the ball diameter 72. Each of the inner and outer raceway radii 74, 76 have corner radii 82 at either end of its groove of 0.001-0.010 inch (0.025-0.254 mm). The total diametral internal radial clearance between the balls 68 and the inner and outer raceway radii 74, 76 is 0.0012-0.0016 inch (0.0305-0.0406 mm).

Providing a deep groove ball bearing arrangement as described above ensures that the reaction loads L, resulting from the gear set surface topology between the input shaft 24 and pinion shaft 34, are spaced from the corner radii 82 and located further within the inner and outer raceway radii 74, 76. In this manner, a ball bearing having a small envelope may be used in applications subject to high non-radial loads.

Although an example embodiment has been disclosed, a worker of ordinary skill in this art would recognize that certain modifications would come within the scope of the claims. For that reason, the following claims should be studied to determine their true scope and content.

What is claimed is:

1. A ram air turbine gearbox comprising:
a pinion shaft arranged in a housing and operatively supporting a pinion gear;
an input shaft arranged in the housing and operatively supporting a ring gear coupled to the pinion gear, the pinion and input shafts oriented at an angle relative to one another; and a rolling element bearing supporting the pinion shaft in the housing, the rolling element bearing including inner and outer races between which a plurality of balls are arranged, each ball having a ball diameter, the inner and outer races respectively including inner and outer raceway radii and inner and outer raceway depth, the inner and outer raceway radii each being approximately 52% of the ball diameter, the inner raceway depth being at a minimum 25% of the ball diameter, and the outer raceway depth being at a minimum 20% of the ball diameter.

2. The ram air turbine gearbox according to claim 1, wherein the inner and outer races and balls provide a total diametral internal radial clearance of 0.0012-0.0016 inch.

3. The ram air turbine gearbox according to claim 2, wherein the rolling element bearing includes nine balls, each having a diameter of approximately 0.3750 inch.

4. The ram air turbine gearbox according to claim 2, wherein the outer race has an outer diameter of approximately 2.4409 inch.

5. The ram air turbine gearbox according to claim 4, wherein the pinion shaft includes a common rolling element bearing supporting a shaft outer diameter arranged on each of either side of the pinion gear.

6. The ram air turbine gearbox according to claim 5, wherein the inner races have an inner diameter of approximately 1.1811 inch and the shaft outer diameter is approximately 1.1817 inch.

7. The ram air turbine gearbox according to claim 6, comprising a lower liner radially engaging one outer race and the housing, the lower liner including inner and outer diameters of approximately 2.4430 inch and 2.5432 inch, respectively.

8. The ram air turbine gearbox according to claim 6, comprising an upper liner radially engaging one outer race and a bearing can, the upper liner including inner and outer diameters of approximately 2.4421 inch and 2.5958 inch, respectively, and an inner diameter of the bearing can is approximately 2.5920 inch.

9. The ram air turbine gearbox according to claim 8, wherein the bearing can radially engages the housing, the housing includes an inner diameter of approximately 3.0650 inch, and an outer diameter of the bearing can is approximately 3.0620 inch.

10. The ram air turbine gearbox according to claim 2, wherein the inner and outer raceway radii include raceway corner radii of 0.001-0.010 inch.

11. A rolling element bearing comprising:
inner and outer races between which a plurality of balls are arranged, each ball having a ball diameter, the inner and outer races respectively including inner and outer raceway radii and inner and outer raceway depth, the inner and outer raceway radii each being approximately 52% of the ball diameter, the inner raceway depth being at a minimum 25% of the ball diameter, and the outer raceway depth being at a minimum 20% of the ball diameter.

12. The rolling element bearing according to claim 11, wherein the inner and outer races and balls provide a total diametral internal radial clearance of 0.0012-0.0016 inch.

13. The rolling element bearing according to claim 12, wherein the rolling element bearing includes nine balls, each having a diameter of approximately 0.3750 inch.

14. The rolling element bearing according to claim 12, wherein the outer race has an outer diameter of approximately 2.4409 inch, and the inner races have an inner diameter of approximately 1.1811 inch.

15. The rolling element bearing according to claim 12, wherein the inner and outer raceway radii include raceway corner radii of 0.001-0.010 inch.

16. A method of installing a rolling element bearing in a ram air turbine gearbox comprising the steps of:
a) installing a rolling bearing element on each of opposing ends of a pinion shaft, the rolling bearing element including inner and outer races between which a plurality of balls are arranged, each ball having a ball diameter, the inner and outer races respectively including inner and outer raceway radii and inner and outer raceway depth, the inner and outer raceway radii each being approximately 52% of the ball diameter, the inner raceway depth being at a minimum 25% of the ball diameter, and the outer raceway depth being at a minimum 20% of the ball diameter; and
b) operatively supporting the pinion shaft in a gearbox housing with the rolling bearing elements.

17. The method according to claim 16, wherein the rolling element bearing includes nine balls, each having a diameter of approximately 0.3750 inch, the outer race has an outer diameter of approximately 2.4409 inch, and the inner races have an inner diameter of approximately 1.1811 inch and the shaft outer diameter is approximately 1.1817 inch.

18. The method according to claim 16, wherein step b) includes installing a lower liner in radial engagement with its respective outer race and the housing, the lower liner including inner and outer diameters of approximately 2.4430 inch and 2.5432 inch, respectively.

19. The method according to claim 16, wherein step b) includes installing an upper liner in radial engagement with its respective outer race and a bearing can, the upper liner including inner and outer diameters of approximately 2.4421 inch and 2.5958 inch, respectively, and an inner diameter of the bearing can is approximately 2.5920 inch, and installing the bearing can in radial engagement with the housing, the housing includes an inner diameter of approximately 3.0650 inch, and an outer diameter of the bearing can is approximately 3.0620 inch.

20. The method according to claim 16, wherein the inner and outer races and balls provide a total diametral internal radial clearance of 0.0012-0.0016 inch.
